(19) United States
(12) Patent Application Publication
(10) Pub. No.: US 2018/0028955 A1
(43) Pub. Date: Feb. 1, 2018

(54) DRIP LEG FOR AIR HANDLING SYSTEM

(71) Applicant: Zaytran, Inc., Elyria, OH (US)

(72) Inventor: Theodore Stanley Zajac, JR., Avon Lake, OH (US)

(21) Appl. No.: 15/219,899

(22) Filed: Jul. 26, 2016

(51) Int. Cl. B01D 45/06; B01D 50/00

(52) U.S. Cl. CPC B01D 45/06; B01D 50/002

(57) ABSTRACT

A sediment trap and air preparation apparatus including the sediment is provided. The sediment trap has a chamber with top and bottom caps, separated by a sidewall that generally encloses an interior region of the chamber. An inlet conduit is coupled to the top cap, where the inlet conduit extends into the interior region of the chamber by at least one-quarter of a length of the chamber. The inlet conduit fluidly couples the interior region of the chamber to an exterior region. An outlet conduit is coupled to the top cap and has first and second outlet axes offset by approximately ninety degrees. The outlet conduit fluidly couples the interior and exterior regions of the chamber. A clean-out conduit is coupled to the bottom cap and further selectively fluidly couples the interior and exterior regions of the chamber. One or more supplemental air preparation apparatuses, are further fluidly coupled to the outlet conduit.

### FIELD

The present invention relates generally to pneumatic systems, and more particularly, to a sediment trap and pneumatic apparatus for air handling systems.

### BACKGROUND

Air handling systems, also called pneumatic systems, are commonplace in various industries, such as the automotive industry. In a typical air handling system, atmospheric air is compressed and provided to various locations throughout a factory floor via supply piping that is often comprised of iron. The compressed air is subsequently filtered, pressure-regulated, oiled, or otherwise conditioned prior to being supplied to pneumatic tooling or other apparatuses requiring pressurized air.

Conventionally, filtering of the compressed air is performed using various filter elements, whereby multiple screens filter various-sized contaminants from the compressed air prior to the compressed air reaching the pneumatic tooling or apparatuses. In a typical factory environment, the quality of incoming air can be poor, and corrosion within the supply piping can be significant. Thus, depending on the condition of the air prior to compression, as well as the condition of the piping and other factors, the filter screens may become saturated or plugged in a relatively short period of time, thus leading to frequent maintenance or replacement of the filter screens.

### SUMMARY

The present disclosure provides a novel system and apparatus for capturing contaminants such as debris, scale, liquids, large particles or sediment within a compressed air system prior to the compressed air being conditioned. Accordingly, the following presents a simplified summary of the invention in order to provide a basic understanding of some aspects of the invention. This summary is not an extensive overview of the invention. It is intended to neither identify key or critical elements of the invention nor delineate the scope of the invention. Its purpose is to present some concepts of the invention in a simplified form as a prelude to the more detailed description that is presented later.

The present disclosure is directed generally toward a sediment trap, also called a drip leg, for substantial removal of contaminants in a stream of compressed air prior to the compressed air being subsequently conditioned. The sediment trap of the present disclosure comprises a chamber having a top cap, a bottom cap, and a sidewall extending between the top cap and bottom cap. The top cap, bottom cap, and sidewall generally enclose an interior region of the chamber. An inlet conduit is operably coupled to the top cap of the chamber. The inlet conduit fluidly couples the interior region of the chamber to an exterior region of the chamber, such as to a source of compressed air.

In accordance with one exemplary aspect, an outlet conduit is further operably coupled to the top cap, wherein the outlet conduit has a first outlet axis and second outlet axis associated therewith. The outlet conduit further fluidly couples the interior region of the chamber to the exterior region of the chamber, such as to one or more supplemental air preparation apparatus. The first outlet axis is generally parallel to the inlet axis, and the second outlet axis is offset from the first inlet axis by approximately 90 degrees. One of the inlet conduit and outlet conduit is further hollow and extends into the interior region of the chamber by at least one-quarter of a length of the chamber along one of the inlet axis and first outlet axis, respectively.

A clean-out conduit is further provided, wherein the clean-out conduit is operably coupled to the bottom cap, and wherein the clean-out conduit selectively fluidly couples the interior region and exterior region of the chamber.

Accordingly, as provided in one exemplary aspect, compressed air carrying various contaminants enters the chamber of the sediment trap from the top of the sediment trap via the inlet conduit, wherein the compressed air exits the inlet conduit in a downward manner within the interior region of the chamber. Once the compressed air exits the inlet conduit, it is forced to travel 180 degrees to exhaust through the outlet conduit, thus allowing the contaminants to fall via gravity to the bottom cap of the chamber.

Advantageously, the present disclosure provides the first outlet axis as being parallel to the inlet axis at the top cap of the chamber, whereby the outlet conduit comprises a 90-degree change in direction of the flow of compressed air, thereby maximizing the degree of fall-out of contaminant material due to gravity, while further changing the direction of flow of the compressed air. A further advantage to the present disclosure is the ability of the second outlet axis to be generally coaxial with additional supplemental air preparation apparatuses, such as filters, regulators, valves, and the like, whereby the sediment trap of the present disclosure minimizes a footprint of the air preparation apparatuses.

In accordance with another example, the clean-out conduit comprises a valve configured to be selectively positioned in an open position and closed position. As such, the valve is configured to selectively fluidly couple the interior region and exterior region of the chamber, wherein in the open position, the valve is configured to evacuate sediment deposited on the bottom cap upon air pressure being applied to the inlet.

According to yet another exemplary aspect, an air preparation system is provided, wherein the air preparation system comprises the above-described sediment trap, in addition to one or more supplemental air preparation apparatuses. As such, the outlet conduit of the sediment trap is fluidly coupled to the one or more supplemental air preparation apparatuses in an advantageous manner. The one or more supplemental air preparation apparatuses, for example, can comprise one or more of an electrically-operated on/off valve, a manually-operated on/off valve, a soft start valve, a distribution module, a branch module, a pressure regulator, an electronic pressure regulator, a particulate filter, a coalescing filter, and a water separator. Accordingly, the second axis of the outlet conduit is coaxial with an inlet to one or more of the one or more supplemental air preparation apparatuses, thus providing a compact air preparation system.

### BRIEF DESCRIPTION OF THE DRAWINGS

FIG. 1 is a schematic representation of an exemplary sediment trap in accordance with one aspect of the present disclosure.

FIG. 2 is a schematic representation of an exemplary air preparation system incorporating a sediment trap in accordance with one aspect of the present disclosure.

FIG. 3 is a cross-sectional illustration of an exemplary sediment trap in accordance with another aspect of the present disclosure.

FIG. 4 is a cross-sectional illustration of yet another exemplary sediment trap in accordance with further aspect of the present disclosure.

### DETAILED DESCRIPTION

The present disclosure will be described with reference to the drawings wherein like reference numerals are used to refer to like elements throughout. It should be understood that the description of these aspects are merely illustrative and that they should not be taken in a limiting sense. In the following description, for purposes of explanation, numerous specific details are set forth in order to provide a thorough understanding of the present disclosure. It will be evident to one skilled in the art, however, that the present disclosure may be practiced without these specific details. In other instances, well-known structures and devices are shown in block diagram form in order to facilitate description of the present disclosure.

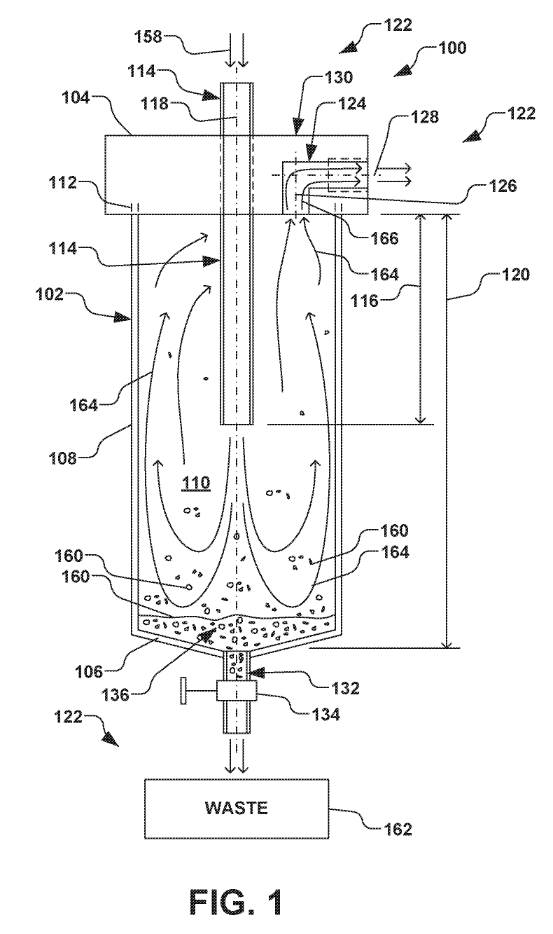

Referring initially to FIG. 1, a sediment trap 100 (also called a drip leg) is provided, wherein the sediment trap is configured to entrain substantial contamination associated with conventional compressed air, such as raw compressed air (e.g., unfiltered air) typically provided by one or more air compressors in a factory environment. Exemplary contaminants may include any debris, scale, dirt or other large particles, as well as liquids such as water and oil. The sediment trap 100 of FIG. 1, for example, comprises a chamber 102 having a top cap 104, a bottom cap 106, and a sidewall 108, wherein the sidewall extends between the top cap and bottom cap. The top cap 104, bottom cap 106, and sidewall 108 generally enclose an interior region 110 of the chamber 102. The top cap 104, for example, may be selectively removable from the sidewall 108 of the chamber 102, such as via one or more engagement members 112 (e.g., one or more screws, bolts, or one or more threads) between the top cap and the sidewall of the chamber. Further, the bottom cap 106 may be integral to the sidewall 108, or may be a separate member operably coupled to the sidewall of the chamber 102.

In accordance with one example, an inlet conduit 114 is operably coupled to the top cap 104 of the chamber 102, wherein the inlet conduit is hollow and extends a predetermined distance 116 into the interior region 110 of the chamber along an inlet axis 118. The predetermined distance 116, for example, is at least one-quarter of a length 120 of the chamber 102. In another example, the predetermined distance 116 is between one-quarter and two-thirds of the length 120 of the chamber 102. The inlet conduit 114 fluidly couples the interior region 110 of the chamber 102 to an exterior region 122 of the chamber. The sidewall 108 of the chamber 102, for example, is circular in cross-section when viewed along the inlet axis 118. In the present example, the inlet axis 118 is centered with respect to the sidewall 108, however other locations of the inlet conduit 114 and inlet axis 118 are contemplated as falling within the scope of the present disclosure.

According to another example, an outlet conduit 124 is operably coupled to the top cap 104, wherein the outlet conduit has a first outlet axis 126 and second outlet axis 128 associated therewith. The outlet conduit 124, for example, fluidly couples the interior region 110 of the chamber 102 to the exterior region 122 of the chamber. The first outlet axis 126, for example, is generally parallel to the inlet axis 118, wherein the second outlet axis 128 is offset from the first inlet axis. In the present example, the second outlet axis 128 is offset from the first inlet axis by approximately 90 degrees. In the present example, the outlet conduit 124 is defined in the top cap 104. However, the present disclosure contemplates other examples, such as the outlet conduit 124 comprising a 90-degree elbow (not shown) operably coupled to a top surface 130 of the top cap 104. Further, it should be noted that while the outlet conduit 124 is described as having a 90-degree bend, the present disclosure further contemplates other offset angles between the second outlet axis 128 and the first outlet axis 126, with the preferred embodiment having an angle of approximately 90 degrees.

A clean-out conduit 132 is further provided, wherein the clean-out conduit is operably coupled to the bottom cap 106. The clean-out conduit 132, for example, further selectively fluidly couples the interior region 110 and exterior region 122 of the chamber 102. The clean-out conduit 132, for example, may be defined in the bottom cap 106, or may be otherwise operably coupled thereto. In one example, the clean-out conduit 132 comprises a valve 134 configured to be selectively positioned in an open position and closed position, therein selectively fluidly coupling the interior region 110 and exterior region 122 of the chamber 102. In the closed position, the valve 134 generally seals clean-out conduit 132 from the exterior region 122, while in the open position, the valve is configured to evacuate sediment 136 deposited on the bottom cap 106 upon air pressure being applied to the inlet conduit 114. In the present example, the clean-out conduit 132 is generally coaxial with the inlet conduit 114, however the clean-out conduit may be offset from the inlet conduit. Further, as illustrated, the bottom cap 106 is beveled downward toward to the clean-out conduit 132 to aid in funneling, as will be discussed infra.

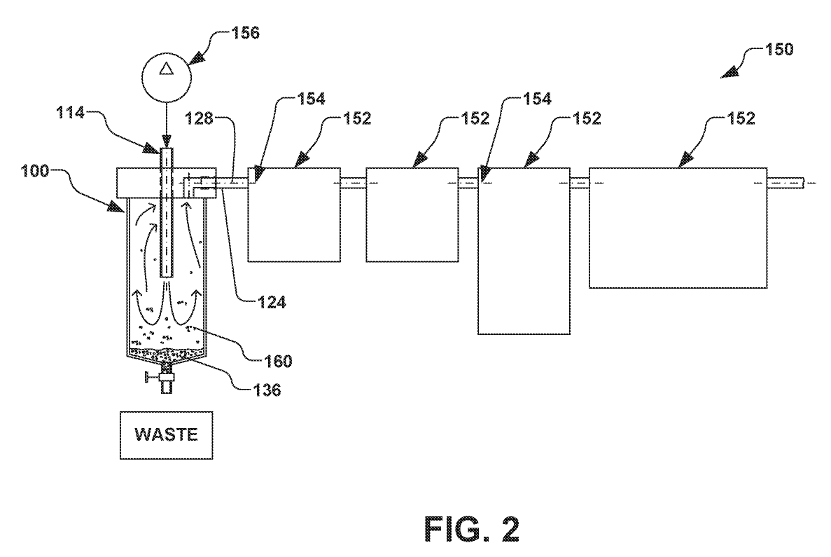

In accordance with another exemplary aspect of the present disclosure, an air preparation apparatus 150 is provided in FIG. 2, wherein the air preparation apparatus comprises the sediment trap 100 of FIG. 1. As illustrated in FIG. 2, the air preparation apparatus 150 further comprises one or more supplemental air preparation apparatuses 152, wherein the outlet conduit 124 is further fluidly coupled to the one or more supplemental air preparation apparatuses. The one or more supplemental air preparation apparatuses 152, for example, comprise one or more of an electrically-operated on/off valve, a manually-operated on/off valve, a soft start valve, a distribution module, a branch module, a pressure regulator, an electronic pressure regulator, a particulate filter, a coalescing filter, and a water separator.

Advantageously, the present disclosure provides the second outlet axis 128 of the outlet conduit 124 as coaxial with an inlet 154 to one or more of the one or more supplemental air preparation apparatuses 152. As such, the one or more supplemental air preparation apparatuses 152 are positioned downstream of the sediment trap 100 in an advantageous manner, wherein a footprint of the air preparation apparatus 150 is minimal. According to another example, the inlet conduit 114 is configured to connect to a source of pressurized air 156, such as an air compressor, or the like.

As illustrated in FIG. 1, unconditioned pressurized air 158 enters the sediment trap 100 through the inlet conduit 114, whereby relatively large contaminants 160 gather on the bottom cap 106 due to gravity. The valve 134 of the clean-out conduit 132 can be selectively opened to remove the settled contaminants 160 to a waste container 162. Due, at least in part, to a location of the outlet conduit 124 being higher than enclosed volume of the chamber 102, substantially greater amounts of contaminant removal is attained by the sediment trap 100 of the present disclosure, as compared to conventional sediment traps. Additionally, the 90-degree offset between the second outlet axis 128 and the first outlet axis 126 provides an additional bend 166 in the paths 164 taken by the contaminants during the flow of air through the sediment trap 100. As such, the present disclosure provides a four- to ten-fold increase in filtering capabilities over conventional sediment traps, thus providing an increased interval between maintenance of the sediment trap.

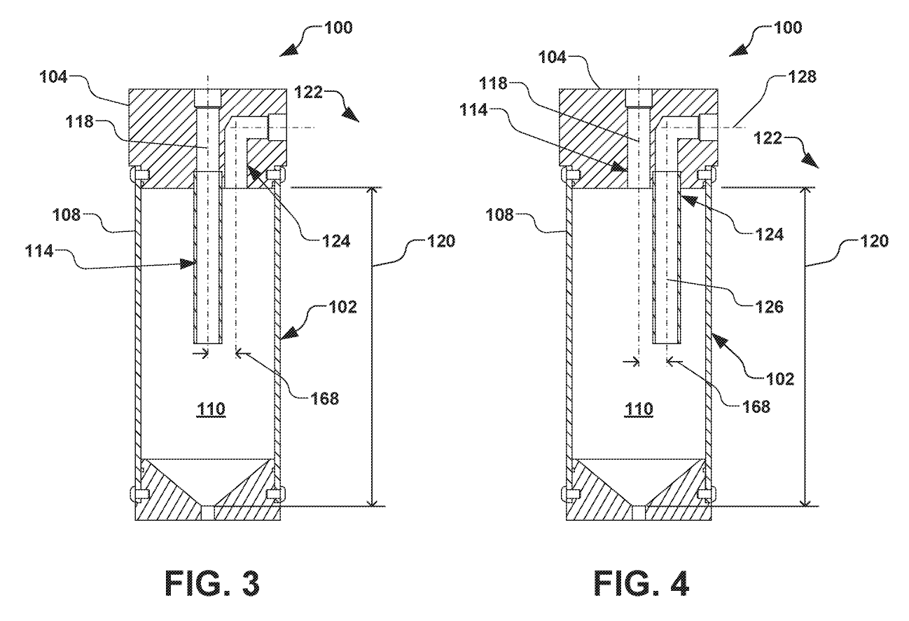

FIGS. 3 and 4 illustrate additional examples in accordance with the present disclosure. As illustrated in FIGS. 3 and 4, the inlet conduit 114 is operably coupled to the top cap 104 of the chamber, wherein the inlet conduit fluidly couples the interior region 110 of the chamber 102 to the exterior region 122 of the chamber along the inlet axis 118. The outlet conduit 124 of the example of each of FIGS. 3 and 4 is defined in the top cap 104 of the chamber 102, wherein the outlet conduit further fluidly couples the interior region 110 of the chamber to the exterior region 122, and wherein the outlet conduit defines the first outlet axis 126 and second outlet axis 128. The first outlet axis 126 is spaced a predetermined distance 168 from the inlet axis 114 and is generally parallel to the inlet axis. As illustrated in FIG. 3, the inlet conduit extends into the interior region 110 of the chamber 102 between one-quarter and two-thirds of the length 120 of the interior region of the chamber. FIG. 4, on the other hand, illustrates the outlet conduit 124 extends into the interior region 110 of the chamber 102 between one-quarter and two-thirds of the length 120 of the interior region of the chamber.

Although the disclosure has been shown and described with respect to certain aspects, equivalent alterations and modifications will occur to others skilled in the art upon the reading and understanding of this specification and the annexed drawings. In particular regard to the various functions performed by the above described components (systems, devices, assemblies, etc.), the terms used to describe such components are intended to correspond, unless otherwise indicated, to any component which performs the specified function of the described component (i.e., that is functionally equivalent), even though not structurally equivalent to the disclosed structure that performs the function in the herein illustrated exemplary aspects of the disclosure. In addition, while a particular feature of the invention may have been disclosed with respect to only one of several aspects, such feature may be combined with one or more other features of the other aspects as may be desired and advantageous for any given or particular application. Furthermore, to the extent that the term “includes” is used in either the detailed description or the claims, such term is intended to be inclusive in a manner similar to the term “comprising.”

What is claimed:

1. A sediment trap, comprising:
a chamber having a top cap, a bottom cap, and a sidewall extending between the top cap and bottom cap, wherein the top cap, bottom cap, and sidewall generally enclose an interior region of the chamber;
an inlet conduit operably coupled to the top cap of the chamber, wherein the inlet conduit fluidly couples the interior region of the chamber to an exterior region of the chamber along an inlet axis;
an outlet conduit operably coupled to the top cap of the chamber, wherein the outlet conduit fluidly couples the interior region of the chamber to the exterior region of the chamber, wherein the outlet conduit defines a first outlet axis and a second outlet axis, wherein the first outlet axis is spaced a predetermined distance from the inlet axis and is generally parallel to the inlet axis, wherein the second outlet axis is offset from the first outlet axis by approximately 90 degrees, and wherein one of the inlet conduit and outlet conduit extends into the interior region of the chamber by at least one-quarter of a length of the interior region of the chamber; and
a clean-out conduit operably coupled to the bottom cap, and wherein the clean-out conduit selectively fluidly couples the interior region and exterior region of the chamber.

2. The sediment trap of claim 1, wherein the inlet conduit extends into the interior region of the chamber along the inlet axis between one-quarter and two-thirds of the length of the interior region of the chamber.

3. The sediment trap of claim 1, wherein the conduit extends into the interior region of the chamber along the first outlet axis between one-quarter and two-thirds of the length of the interior region of the chamber.

4. The sediment trap of claim 1, wherein the outlet conduit comprises a 90-degree elbow operably coupled to the top cap, therein defining the first outlet axis and second outlet axis.

5. The sediment trap of claim 1, wherein the outlet conduit comprises a 90-degree bend defined in the top cap, therein defining the first outlet axis and second outlet axis.

6. The sediment trap of claim 1, wherein the top cap is selectively removable from the sidewall of the chamber.

7. The sediment trap of claim 1, wherein the clean-out conduit is defined in the bottom cap.

8. The sediment trap of claim 1, wherein the clean-out conduit comprises a valve configured to be selectively positioned in an open position and closed position, therein selectively fluidly coupling the interior region and exterior region of the chamber, wherein in the open position, the valve is configured to evacuate sediment deposited on the bottom cap upon air pressure being applied to the inlet conduit.

9. The sediment trap of claim 1, wherein the sidewall of the chamber is circular in cross-section when viewed along the inlet axis, and wherein the inlet axis is centered with respect to the sidewall.

10. The sediment trap of claim 1, wherein the inlet conduit is configured to connect to a source of pressurized air, and wherein the outlet conduit is fluidly coupled to one or more supplemental air preparation apparatuses.

11. The sediment trap of claim 10, wherein the second outlet axis is coaxial with an inlet to the one or more supplemental air preparation apparatuses.

12. The sediment trap of claim 11, wherein the one or more supplemental air preparation apparatuses comprise one or more of an electrically-operated on/off valve, a manually-operated on/off valve, a soft start valve, a distribution module, a branch module, a pressure regulator, an electronic pressure regulator, a particulate filter, a coalescing filter, and a water separator.

13. An air preparation apparatus, comprising:
a sediment trap, the sediment trap comprising:
a chamber having a top cap, a bottom cap, and a sidewall extending between the top cap and bottom cap, wherein the top cap, bottom cap, and sidewall generally enclose an interior region of the chamber;
an inlet conduit operably coupled to the top cap of the chamber, wherein the inlet conduit fluidly couples the interior region of the chamber to an exterior region of the chamber along an inlet axis;
an outlet conduit operably coupled to the top cap and having a first outlet axis and second outlet axis associated therewith, wherein the outlet conduit fluidly couples the interior region of the chamber to the exterior region of the chamber, and wherein the first outlet axis is generally parallel to the inlet axis, and wherein the second outlet axis is offset from the inlet axis by approximately 90 degrees, and wherein one of the inlet conduit and outlet conduit extends into the interior region of the chamber by at least one-quarter of a length of the interior region of the chamber;
a clean-out conduit operably coupled to the bottom cap, and wherein the clean-out conduit selectively fluidly couples the interior region and exterior region of the chamber; and
one or more supplemental air preparation apparatuses, wherein the outlet conduit is fluidly coupled to the one or more supplemental air preparation apparatuses.

14. The air preparation apparatus of claim 13, wherein the one or more supplemental air preparation apparatuses comprise one or more of an electrically-operated on/off valve, a manually-operated on/off valve, a soft start valve, a distribution module, a branch module, a pressure regulator, an electronic pressure regulator, a particulate filter, a coalescing filter, and a water separator.

15. The air preparation apparatus of claim 13, wherein the second outlet axis of the outlet conduit is coaxial with an inlet to one or more of the one or more supplemental air preparation apparatuses.

16. The air preparation apparatus of claim 13, wherein the inlet conduit extends into the interior region of the chamber along the inlet axis between one-quarter and two-thirds of the length of the interior region of the chamber.

17. The air preparation apparatus of claim 13, wherein the outlet conduit extends into the interior region of the chamber along the first outlet axis between one-quarter and two-thirds of the length of the interior region of the chamber.

18. The air preparation apparatus of claim 13, wherein the outlet conduit comprises a 90-degree elbow operably coupled to the top cap, therein defining the first outlet axis and second outlet axis.

19. The air preparation apparatus of claim 13, wherein the outlet conduit comprises a 90-degree bend defined in the top cap, therein defining the first outlet axis and second outlet axis.

20. The air preparation apparatus of claim 13, wherein the top cap is selectively removable from the sidewall of the chamber.
